(19) United States
(12) Patent Application Publication
(10) Pub. No.: US 2010/0122270 A1
(43) Pub. Date: May 13, 2010

(54) System And Method For Consolidating Events In A Real Time Monitoring System

(76) Inventor: Yeejang James Lin, San Jose, CA (US)

Correspondence Address: Wang Law Firm, Inc., 4989 Peachtree Parkway,, Suite 200, Norcross, GA, 30092, US

(21) Appl. No.: 12/578,285

(22) Filed: Oct. 13, 2009

Related U.S. Application Data
(60) Provisional application No. 61/113,719, filed on Nov. 12, 2008.

(51) Int. Cl. G06F 9/44

(52) U.S. Cl. 719/318

(57) ABSTRACT

The present invention provides a monitoring device and method for consolidating data collected by the monitoring device. The data collected are labeled with an identification and stored in a flat file. The collected data are then filtered and the filtered data are saved as events in an event database. These events are the reduced by grouping similar events together. The reduction is performed periodically and at different levels. The reduced set of data is presented to the user and each individual collected datum behind the reduced data may be retrieved.

### RELATED APPLICATION

This application claims benefits of the U.S. Provisional Application for Method For Consolidating And Automating Events And Reports, U.S. Provisional Pat. App. No. 61/113,719, filed on Nov. 12, 2008, the specification of which is included in its entirety by this reference.

### BACKGROUND OF THE INVENTION

1. Field of the Invention

The present invention generally relates to real time event monitoring, and more specifically, relates to a system and method that handles a large amount of data.

2. Description of the Related Art

Information equals to power and having access to the right information equals having a competitive advantage over others in today's world. Each company closely guards the information essential to their business. Traditionally, the access to sensitive information of each company is restricted to a small number of authorized personnel and each company tracks the access to this information.

Tracking information access to sensitive information in a network means monitoring each access request and corresponding response. In a system with multiple files and many users, the monitoring of every access request and every response can result in a huge amount of data that overwhelms any system very quickly and makes processing very difficult. The large amount of data overwhelms memory and computer processing power. To process this large amount of data many memory swaps may be needed that will increase the processing load for the computer.

Therefore, there is a need for a system and method that can handle a large amount of data from a monitoring system and it is to this system the present invention is primarily directed to.

### SUMMARY OF THE INVENTION

In one embodiment, the present invention provides a method for consolidating data collected by a monitoring device. The method comprises receiving a plurality of instances of monitored data from a monitoring port, retrieving filtering criteria from a storage unit, filtering the plurality of instances according to the filtering criteria, storing filtered instances as events in a database in the storage unit, and reducing the number of the events by grouping the events according to a first set of user-defined policy.

In another embodiment, there is also provided a monitoring device capable of consolidating data collected in a data network. The monitoring device comprises at least one monitoring port for receiving data from at least one monitoring point, a storage unit for storing the received data and the parsed data, and a controller for filtering received data according to first set of user-defined criteria and reducing the filtered data according to second set of user-defined criteria.

The present system and methods are therefore advantageous as they enable reduction of data to be manipulated by a monitoring system. Other advantages and features of the present invention will become apparent after review of the hereinafter set forth Brief Description of the Drawings, Detailed Description of the Invention, and the Claims.

### BRIEF DESCRIPTION OF THE DRAWINGS

Features and advantages of embodiments of the invention will become apparent as the following detailed description proceeds, and upon reference to the drawings, where like numerals depict like elements, and in which:

FIG. 1 depicts a network architecture according to the present invention;

FIG. 2 illustrates a flow chart 200 for processing of raw data;

FIG. 3 illustrates few examples of assigning identifications to elements in each category;

FIG. 4 depicts a model for consolidating events;

FIG. 5 is another illustration of the pre-processing (reduction) described in FIG. 4;

FIG. 6 is an example of how events can be combined or grouped;

FIG. 7 is an illustration of the relationship among intermediate results of reduction;

FIG. 8 illustrates an example for reviewing the data;

FIG. 9 is architecture for a monitoring device; and

FIG. 10 is a flow chart for the a processing and reduction process performed by the present invention.

### DETAIL DESCRIPTION OF THE INVENTION

In this description, the term “application” as used herein is intended to encompass executable and non-executable software files, raw data, aggregated data, patches, and other code segments. The term “exemplary” is meant only as an example, and does not indicate any preference for the embodiment or elements described. Further, like numerals refer to like elements throughout the several views, and the articles “a” and “the” includes plural references, unless otherwise specified in the description.

In an overview, the present invention provides a system and method for consolidating events in a monitoring system, where each event represents a datum recorded by the monitoring system. An effective monitoring system must be able to monitor as many operations as possible and as result the monitoring system will generate a huge amount of data, which makes almost impossible for processing unless the computer has a large memory and large computing capacity. The present invention introduces a method for consolidating the events that makes the consolidated events manageable and yet easy for a user to retrieve an actual event of interest.

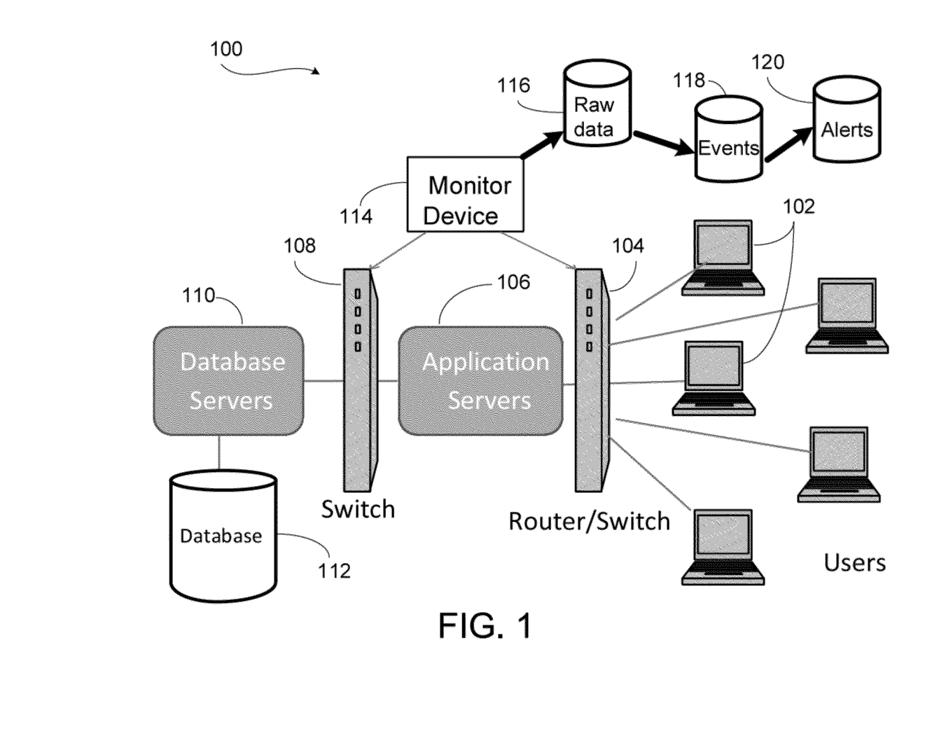

FIG. 1 illustrates a network architecture 100 according to the present invention. The remote users may use any of computers, workstations, or terminals 102 connected to a data network or a switch/router 104. The users may be workers in a company located in one single location or located in different geographical areas. A user may run an application located on an application server 106 and during execution of the application, requests for certain information located in a database 112 may be requested by the user. The request initiated from a terminal 102 is sent through the router 104 to the application server 106. The application server 106 sends the request to a database server 110. The database server 110 may be connected directly to the application server 106 or may be located remotely from the application server 106 and connected to the application server 106 through a switch 108. After receiving the request, the database server 110 can then retrieve the requested data from a database 112. The requested data then travels back to the terminal 102 from which the request was initiated.

To monitor the access to the database server 110 a monitoring device 114 is introduced. The monitoring device 114 monitors data traffic passing through the router 104 and switch 108. Each request from a remote terminal 102 is recorded as an instance and its content analyzed. Each response from the database server 110 is also recorded as an instance and analyzed. Each database access is translated into a SQL (structure query language) query along with a SQL response. The monitoring device 114 monitors every request made by any user and every single request and its response is recorded in a raw database 116. As there may be many users and many databases, the raw data collected, i.e. instances collected, will increase very rapidly. The raw data in the raw database 116 are processed and filtered according to a plurality of sets of user-definable policies and the results are stored in an event database 118. The number of the events is comparatively smaller than the number of records in the raw database 116. The events in the event database 118 can be further consolidated and reduced and the number of the events will be reduced to be more manageable. The resulting events can be further processed according to user defined criteria and those with urgency are stored in an alert database 120.

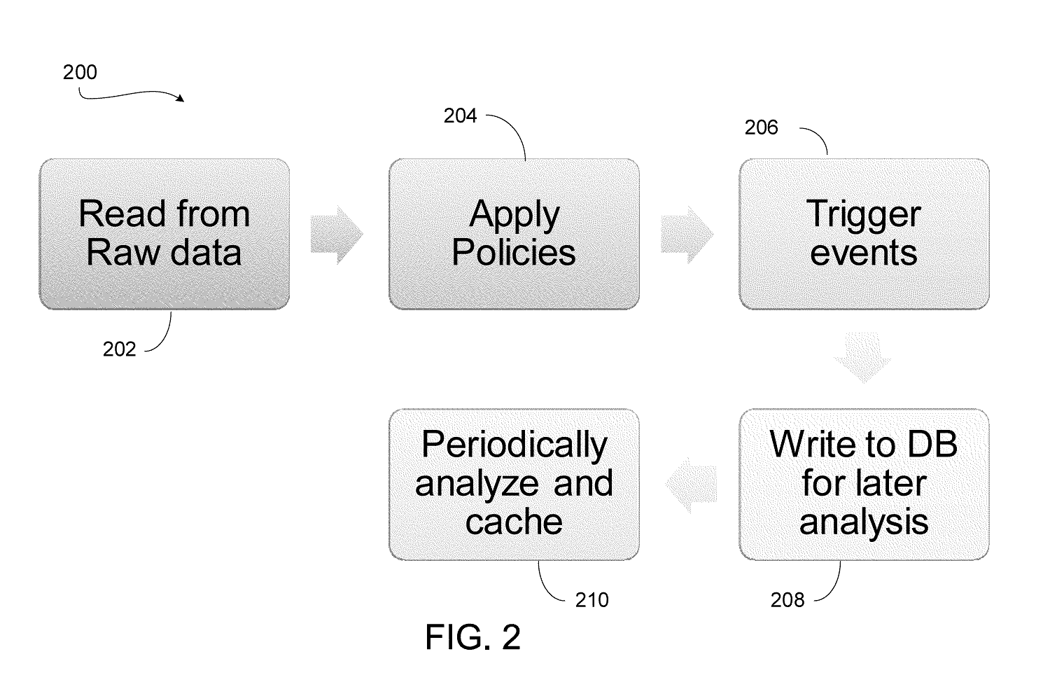

Generally speaking events are important instances that are triggered by policies or behavior profiles. Alerts are urgent events that are triggered by user-defined action to urgently inform those who are responsible to take actions. Number of events and alerts are significantly less than raw data (instances) and they are important audit data for analysis of the system and generation of reports. FIG. 2 illustrates a flow chart 200 for processing of raw data. The raw data is read, step 202, from the raw database 116, and a set of policies is applied, step 204. As the result of application of policies, events are triggered, step 206, and these events are written into the event database 118 for later analysis, step 208. These events can be further analyzed, step 210.

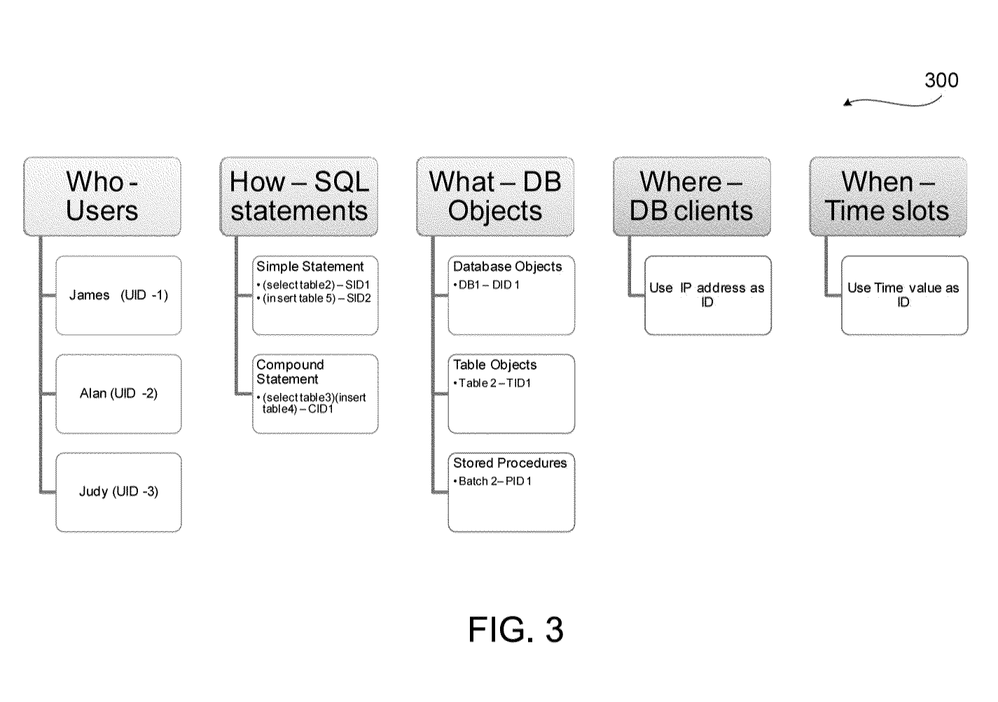

Each information access in the network shown in FIG. 1 is an instance and typically consists of a query and a response. The instance is recorded without any chance. Since the number of instances is very large and requires a huge storage space, an optimization is performed over these instances. The optimization is done using an information model to represent each instance. Each instance is decomposed into five categories: users, methods, objects, places, and time. These five categories are defined and explained in the sister application for System And Method For Detecting Behavior Anomaly In Information Access, U.S. patent application Ser. No. 12/431,946, filed on Apr. 29, 2009, the specification of which is incorporated in its entirety by this reference. Each instance recorded is assigned a shorthand identification. FIG. 3 illustrates few examples of assigning identifications to elements in each category. For example, user James who initiates an access request may be assigned to user identification (UID) 1, user Alan assigned UID 2, etc. A simple SQL statement may be assigned statement identification (SID) 1 and a compound statement may be assigned CID 1. These shorthand identifications can then be used later during the consolidation of events.

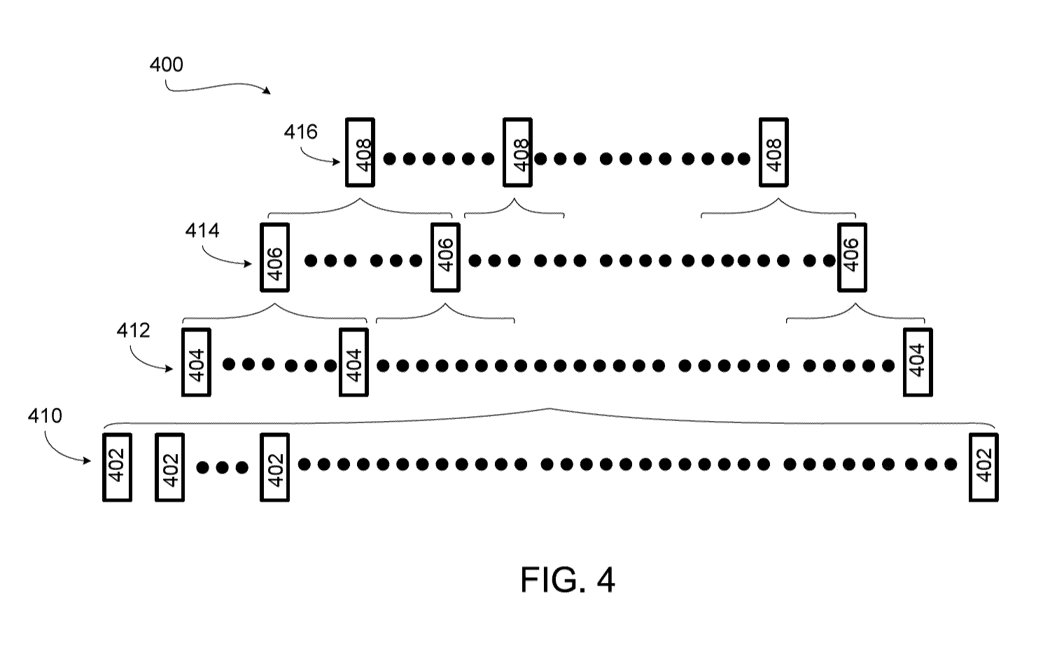

FIG. 4 depicts a model 400 for consolidating events of different time durations. The instances 402 recorded by a monitoring device 114 are tagged and stored in the raw database 116. The raw database 116 is preferably implemented as a fiat file, so the space used is minimized. The event database 118 and alert database 120 are preferably implemented as regular databases that would allow flexible access. The instances 402 are first filtered according to filtering criteria set by users and the resulting events 404 are further reduced. For example, one filtering criterion may be to select all accesses to object A and B, then all instances of access requests to these two objects will be selected and stored in an event database 118. One way to further reduce the events 404 in the event database 118 is to group them periodically. The events 404 that happen within one second and are similar are grouped together into second-events 406. So, many events 404 shown in row 412 are reduced into second-events 406 shown in row 414. The second-events 406 can be further consolidated in the similar manner. The second-events 406 can be consolidated into minute-events 408 shown in row 416 and this consolidation process can continue according to a user-defined policy. FIG. 4 is a visualization of the reduction process and this reduction process is repeated periodically. Though, the time is used as the factor for pre-processing in the example of FIG. 4, other factors may also be used. For example, geographic location may also be used if the monitoring device is monitoring many end users distributed through a vast area or an open network.

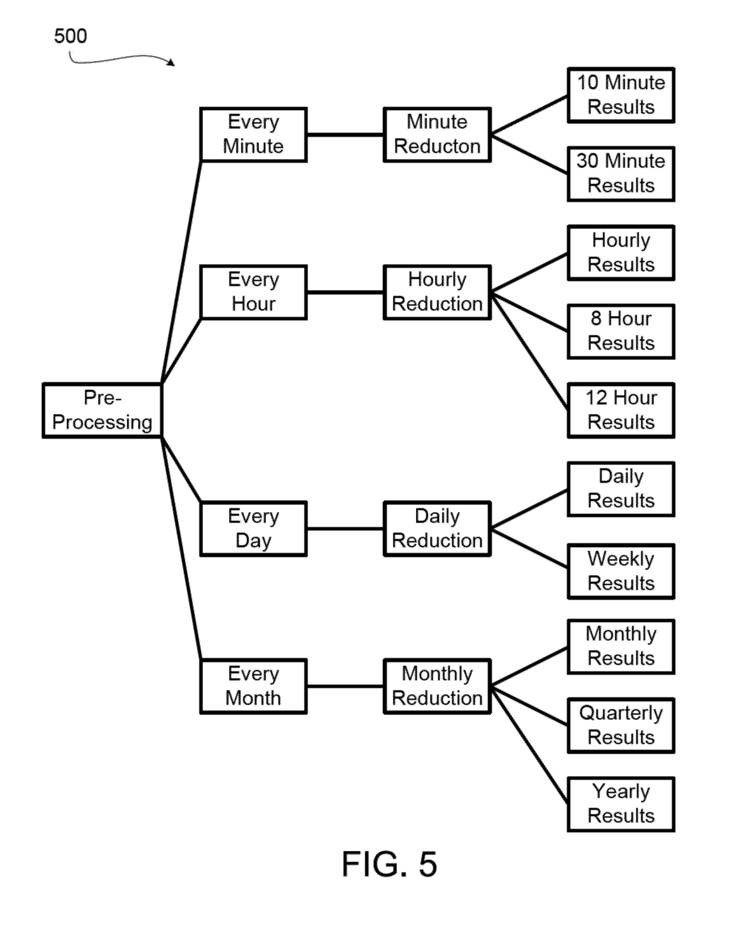

FIG. 5 is another illustration 500 of the pre-processing (reduction) described in FIG. 4. The pre-processing may be done every minute, every hour, every day, or every month. The results from each processing can be further processed to reduce the resulting set even more. For example, the minute reduction results can produce a set of 10-minute results and also a set of 30-minutes results as shown in FIG. 5. From the hourly reduction results a set of 8-hour results and a set of 12-hour results may be generated. The reduction shown above allows analysis of collected information be divided into small operations. Instead of analysis the collected information all at once, now the analysis can be done for only weekly results or daily results.

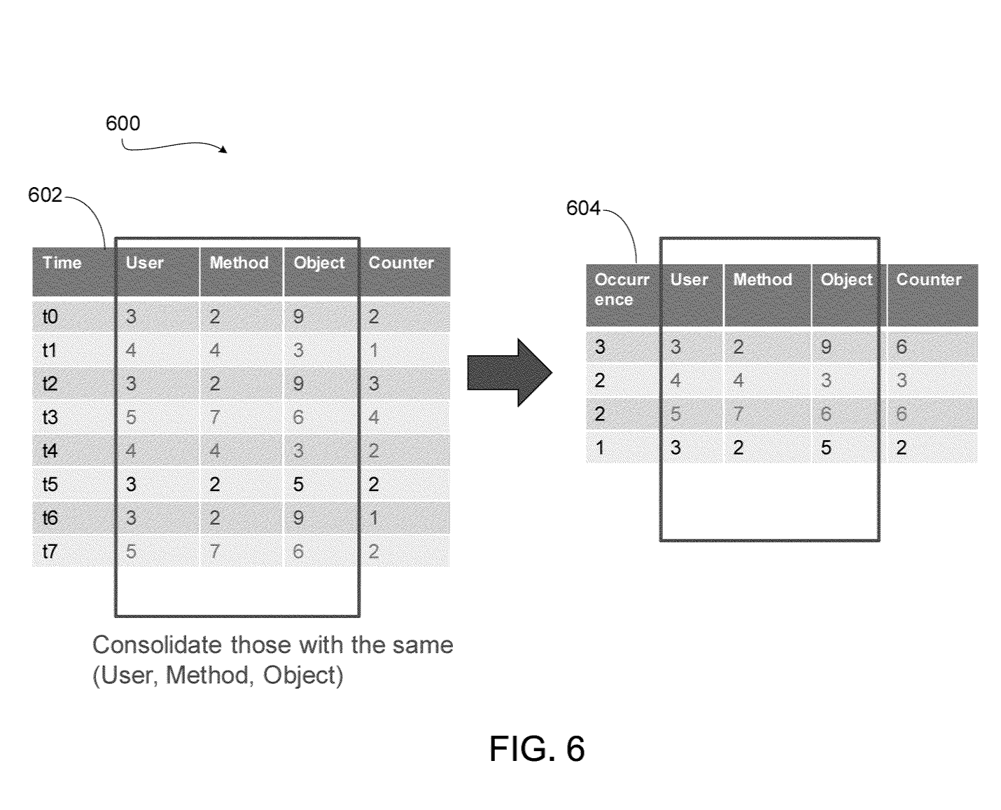

The reduction shown in FIG. 5 may be achieved by different methods. For example, events with same user, method, object, and location may be combined. FIG. 6 is an example 600 of how events can be combined or grouped. Table 602 contains events recorded at different times. For user identified as number 3, four events are recorded—time t0, time t2, time t5, and time t6. In three of these events, user 3 uses method 2 to access object 9, so they may be combined into one entry in table 404. In table 604, the number of occurrence for the entry for user 3 would be marked as 3. The events in table 602 are combined into table 604. Besides the entry for user 3, the entry for user 4 is marked with occurrence of 2 because user 4 used method 4 twice to access object 3. There is an additional entry for user 3 in table 604. This second entry for user 3 is for user 3 using method 2 to access object 5. Because the object access is 5 instead of 9, this second entry for user 3 cannot be combined with the first entry for user 3. As it can be seen in FIG. 6, the criteria used to combine the events are the user ID, object ID, and method ID. It is understood that other criteria may also be used. For example, if the system administrator wants to know how often certain command has been used, then the criterion will be the method ID.

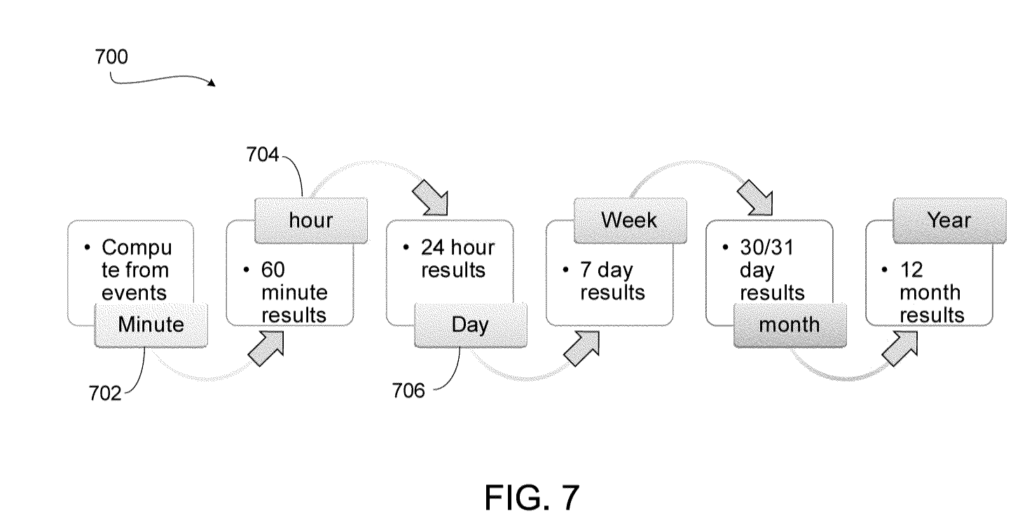

FIG. 7 is an illustration 700 of the relationship among intermediate results of reduction. As shown, minute-results 702 are computed from filtered events and the minute-results 702 can be used to generate hour-results 704. The hour-results 704 can then be used to generate day-results 706, so on so forth.

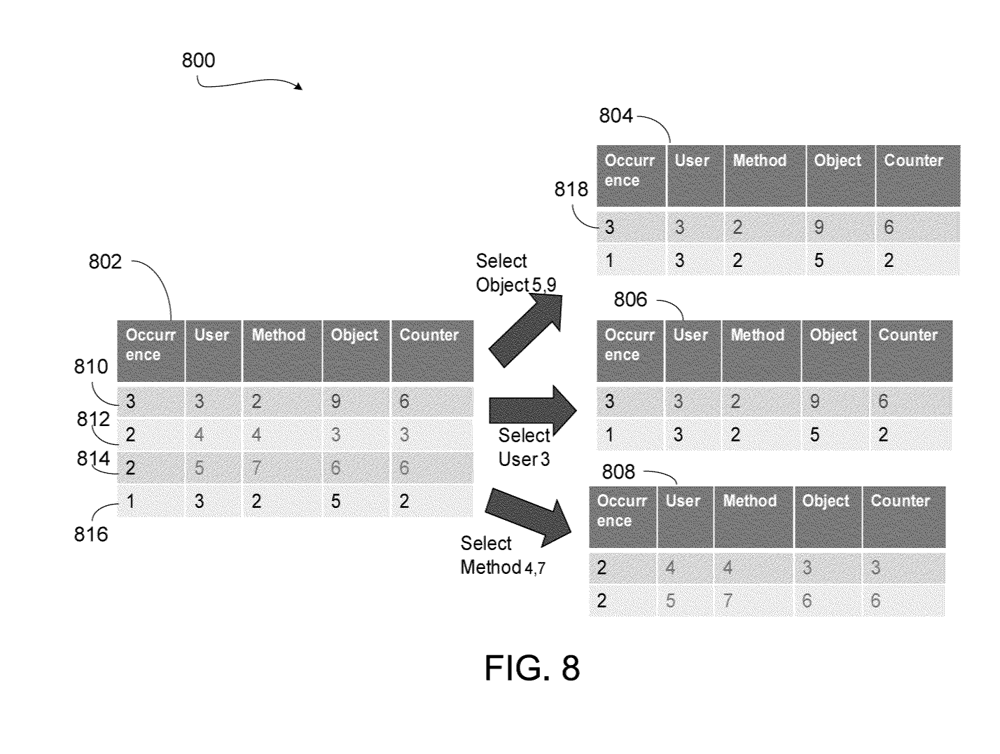

After the collected instances are processed as described above, the processed information can be stored in the event database 118 and those events with urgency are filtered and stored in the alert database 120. The information stored can then easily be analyzed and reported to a system administrator. The system administrator can set up filtering conditions to review the stored information. The filtering may be by element, element member, combination of element members, etc. The system administrator may also select information from a particular time period for review. The system administrator may select a particular minute, hour, day, or any combination to review. FIG. 8 illustrates an example 800 for reviewing the data. Table 802 may be a report for a particular week. The system administrator can set a filter to select operations related to objects 5 and 9, and entries 810 and 816 will be selected and presented as shown in table 804. If the filter is set for operations requested by user 3, then entries 810 and 816 will be selected. If the administrator wants to know who has invoked methods 4 and 7, then entries 812 and 814 will be selected. Since the actual transaction data (instances) are stored and labeled, this allows the system administrator to review the actual transaction data. For example, if the system administrator is interested to learn more about entry 818 in table 804, he can select that entry and the actual transactions (instances) for that entry 818 will be retrieved from the raw database 116 and displayed.

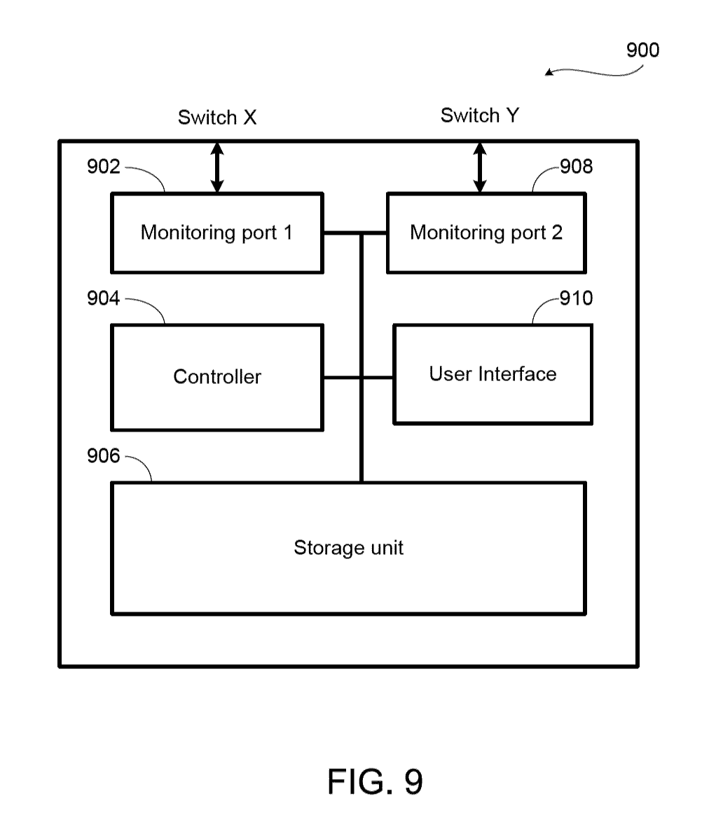

The method of the present invention can be performed by a program resident in a computer readable medium, where the program directs a server or other computer device having a computer platform to perform the steps of the method. The computer readable medium can be the memory of the server, or can be in a connective database. Further, the computer readable medium can be in a secondary storage media that is loadable onto a networking computer platform, such as a magnetic disk or tape, optical disk, hard disk, flash memory, or other storage media as is known in the art. A system 900 supporting such method is shown in FIG. 9.

FIG. 9 is architecture 900 for a monitoring device 114. The monitoring device 114 may have one or more monitoring port, 902, 908, for connecting to two or more monitoring points. The monitoring device 114 includes a controller 904, a user interface unit 910, and a storage unit 906. The controller 904 checks the collected data, filter and reduce them according to user-defined policies, and store them in the storage unit 906. The user interface unit 910 displays the data to the system administrator and receives filtering commands from the system administrator. The controller 904 will filter and select data and change display data according to the filtering commands. Though separate units are shown, they can easily be replaced by one or multiple hardware units capable of performing similar functions.

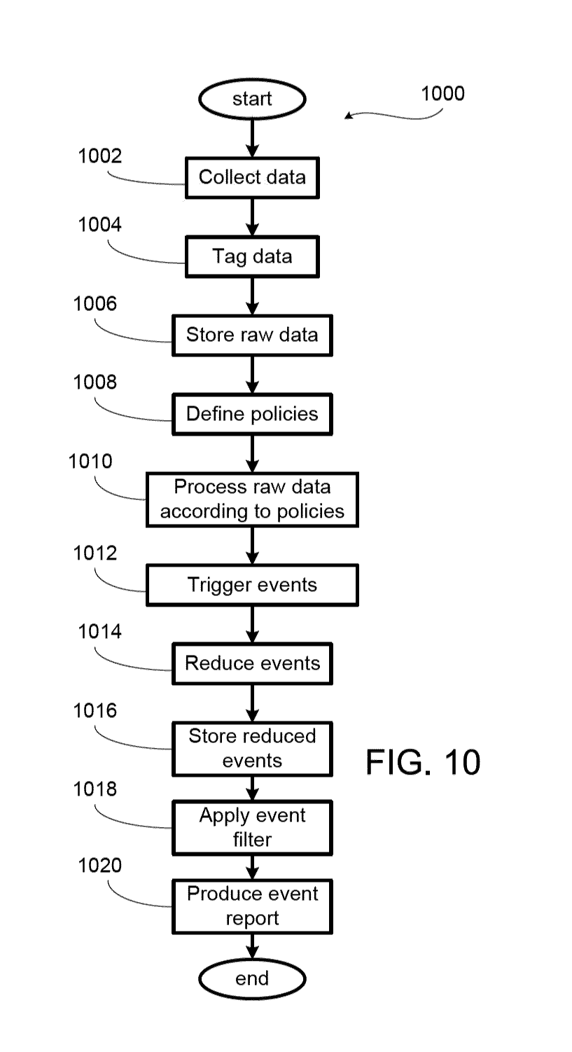

FIG. 10 is a flow chart 1000 for the pre-processing and reduction process performed by the present invention. The monitoring device 114 collects data, step 1002, and tags each data, step 1004. The collected data are stored, step 1006. The system administrator can define a set of policies, step 1008, to be applied to the stored raw data. The stored raw data are filtered according to user defined policies, step 1010, and the resulting data (events) are stored, step 1012. These events can be further reduced to save the storage space and also to make reviewing easier, step 1014. Similar events are grouped through the reduction step. The grouping may be done according to different user-defined criteria and one user-defined criterion may be grouping events that have same user ID and same object if the system administrator wants to know which files a user has accessed. The resulting reduced events are stored, step 1016. These reduced events can then be filtered according to user defined event filters, step 1018. The reduced events can then be displayed as event report to the system administrator. The desired event reports can be produced fast by combining reduced events of interested duration, step 1020. For example, this invention takes advantage of event preprocessing to efficiently produce weekly reports from daily reports, and monthly reports from daily reports. Those events that have a higher urgency are stored and displayed as alerts.

In operation, the monitoring device may monitor and collect data from a network. Each collected datum may be tagged with a time stamp and user identification. The collected data are stored as flat file. The collected data may be filtered according to a filtering criteria defined by the system administrator. If the system administrator wants to know all the access to an accounting file, then all the access requests to this accounting file are filtered out and stored as events in a separated event database. The number of filtered events may be large and hard to review and to make review easier, they can be grouped. The grouping may be done through several stages. A first stage may be to group access requests from a particular user during a particular hour. A later stage may further group the events for that particular day. Through this grouping, the number of events stored may be reduced significantly, thus saving the storage place and making easier to be processed. The intermediate results may be stored temporarily and later discarded. For example, second-events may be stored for one hour before being discarded, and minute-events may be stored for 6 hours before being discarded. Discarding these intermediate results further reduced the memory space used. Discarding the intermediate results does not affect the information retrieval since the originally collected instances are stored. The system administrator can retrieve any particular instance of the collected data easily because each instance has been tagged and identified.

The intermediate results from pre-processing can be easily combined to produce reports for any time period, and the intermediate results are used as building blocks. For example, daily reports can be combined to produce weekly reports or monthly reports. By using the intermediate results as building blocks, the event reports can be assembled much faster. As described above, a month report can be assembled from daily reports instead of starting from scratch using the raw data collected. Besides being grouped on time basis, the events may also be selected through event filters that may be set by the system administrator. By setting different parameters for the event filters, different event reports can be generated from the intermediate results.

In the context of FIG. 10, the steps illustrated do not require or imply any particular order of actions. The actions may be executed in sequence or in parallel. The method may be implemented, for example, by operating portion(s) of a network device, such as a network router or network server, to execute a sequence of machine-readable instructions. The instructions can reside in various types of signal-bearing or data storage primary, secondary, or tertiary media. The media may comprise, for example, RAM (not shown) accessible by, or residing within, the components of the network device. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, EPROM, or EEPROM), flash memory cards, an optical storage device (e.g. CD-ROM, WORM, DVD, digital optical tape), paper “punch” cards, or other suitable data storage media including digital and analog transmission media. The instructions when executed by a computer will enable the computer to perform the steps illustrated in FIG. 10.

While the invention has been particularly shown and described with reference to a preferred embodiment thereof, it will be understood by those skilled in the art that various changes in form and detail may be made without departing from the spirit and scope of the present invention as set forth in the following claims. Furthermore, although elements of the invention may be described or claimed in the singular, the plural is contemplated unless limitation to the singular is explicitly stated. The combinations of different features described separately in this specification are foreseeable and within the scope of the invention.

What is claimed is:

1. A method for consolidating data collected by a monitoring device, comprising the steps of:
receiving a plurality of instances of monitored data from a monitoring port;
retrieving filtering criteria from a storage unit;
filtering the plurality of instances according to the filtering criteria;
storing filtered instances as events in a database in the storage unit; and
reducing the number of the events by grouping the events according to a first set of user-defined policy.

2. The method of claim 1, further comprising the step of labeling each instance with an identifier.

3. The method of claim 2, further comprising the steps of:
receiving a selection a grouped event from a user;
identifying instances associated to the grouped event by the identifier; and
retrieving the identified instances associated with the grouped event.

4. The method of claim 1, further comprising the step of retrieving the first set of user-defined policy from the storage unit.

5. The method of claim 1, further comprising the steps of:
filtering the events according to a second set of user-defined policy; and
storing filtered events as alerts in an alert database in the storage unit.

6. The method of claim 1, wherein the first set of user-defined policy being grouping events with same user identity and same object accessed.

7. The method of claim 1, wherein the first set of user-defined policy being grouping the events on a first time period basis, further comprising the steps of:
grouping the events into a first time period based intermediate results;
generating a report for a second time period using the first time period based intermediate results.

8. The method of claim 1, wherein the reducing step being repeated periodically.

9. The method of claim 1, further comprising the step of storing the plurality of instances of monitored data in a flat file in the storage unit.

10. The method of claim 1, further comprising the steps of:
setting an event filter; and
generating an event report according to the event filter.

11. A monitoring device capable of consolidating data collected in a data network, comprising:
at least one monitoring port for receiving data from at least one monitoring point;
a storage unit for storing the received data and the parsed data; and
a controller for filtering received data according to first set of user-defined criteria and reducing the filtered data according to second set of user-defined criteria.

12. The monitoring device of claim 11, further comprising a user interface unit for displaying the reduced data.

13. The monitoring device of claim 11, wherein the received data being stored in a flat file in the storage unit.

14. The monitoring device of claim 11, wherein the reduced data being stored in a database file in the storage unit.

15. A computer program residing on a computer-readable medium for consolidating data collected by a monitoring device, the monitoring device being connected to a plurality of monitoring points, the monitoring device having at least one monitoring port, a controller, a display unit, and a storage unit, the computer program when executed by the monitoring device causes the monitoring device to perform the following steps:
receiving a plurality of instances of monitored data from a monitoring port;
retrieving filtering criteria from the storage unit;
filtering the plurality of instances according to the filtering criteria;
storing filtered instances as events in a database in the storage unit; and
reducing the number of the events by grouping the events according to a first set of user-defined policy.

16. The computer program of claim 15, further causing the monitoring device to perform the step of labeling each instance with an identifier.

17. The computer program of claim 16, further causing the monitoring device to perform the steps of:
receiving a selection a grouped event from a user;
identifying instances associated to the grouped event by the identifier; and
retrieving the identified instances associated with the grouped event.

18. The computer program of claim 15, further causing the monitoring device to perform the step of retrieving the first set of user-defined policy from the storage unit.

19. The computer program of claim 15, further causing the monitoring device to perform the steps of:
filtering the events according to a second set of user-defined policy; and
storing filtered events as alerts in an alert database in the storage unit.

20. The computer program of claim 15, further causing the monitoring device to perform the step of storing the plurality of instances of monitored data in a flat file in the storage unit.

21. The computer program of claim 15, further causing the monitoring device to perform the steps of:
setting an event filter; and
generating an event report according to the event filter.
